(19) United States
(12) Patent Application Publication
(10) Pub. No.: US 2013/0209028 A1
(43) Pub. Date: Aug. 15, 2013

(54) ELECTRICAL OPTICAL CIRCUIT-BOARD, CIRCUIT-BOARD APPARATUS, AND PHOTOELECTRIC COMPOSITE DEVICE

(71) Applicants: Makoto Fujiwara, Utsunomiya-shi (JP); Kimio Moriya, Utsunomiya-shi (JP)

(72) Inventors: Makoto Fujiwara, Utsunomiya-shi (JP); Kimio Moriya, Utsunomiya-shi (JP)

(73) Assignee: SUMITOMO BAKELITE CO., LTD., Tokyo (JP)

(21) Appl. No.: 13/878,099

(22) PCT Filed: Oct. 6, 2011
(86) PCT No.: PCT/JP2011/073091

§ 371 Date: Apr. 26, 2013

(30) Foreign Application Priority Data
Oct. 8, 2010 (JP) 2010-228939

(51) Int. Cl. G02B 6/12

(52) U.S. Cl. CPC G02B 6/12
USPC 385/14

(57) ABSTRACT

An electrical optical circuit-board (10) is provided with an optical circuit-board (40) provided with an optical waveguide (42) and an electrical wiring board (70) that contains a conductor layer (72) and is laminated on the optical circuit-board (40). In the electrical optical circuit-board (10), the electrical wiring board (70) is provided with extending portions (74) formed extending beyond the optical circuit-board (40) laterally with respect to the extending direction of the optical waveguide (42), and conductive portions (50) are provided in a middle portion M of the electrical wiring board (70) in the extending direction thereof that connect the conductor layer (72) and the back side of the electrical optical circuit-board (10).

### TECHNICAL FIELD

The present invention relates to an electrical optical circuit-board provided with an optical circuit-board and an electric wiring board, a circuit-board apparatus comprising the electrical optical circuit-board and an electrical circuit-board, and a photoelectric composite device on which an optical device and electrical device are mounted.

### BACKGROUND ART

With respect to this type of technology, Patent Document 1 describes a method for producing an electrical optical circuit-board that comprises fabricating an electrical wiring board provided with an optical waveguide by adhering an optical circuit-board patterned with an optical waveguide and an electrical wiring board installed with an electrical device with a sheet-like adhesive over the entire surface thereof. Furthermore, pattern formation (or patterning) refers to the formation of wiring that propagates a signal or electrical power, and optical waveguide pattern formation refers to the formation of a core portion for propagating optical signals, while conductor layer pattern formation refers to the formation of wiring for supplying an electrical signal or electrical power.

Patent Document 2 describes an optical transmission and reception module (electrical optical circuit-board) in which an electrical wiring layer is formed on one of the main surfaces of a band-like optical waveguide film, and this electrical wiring layer is covered with a protective layer. In this optical transmission and reception module, an optical transmission and reception portion is provided with electrode pads formed on both ends in the lengthwise direction, while a middle portion in the lengthwise direction is in the form of a band in which an optical waveguide core extends linearly. This type of band-like electrical optical circuit-board is used by installing along an electrical circuit-board (multilayer printed circuit-board) by using a pair of optical connectors mounted on the electrical circuit-board as both ends thereof. In this case, since an optical waveguide can be installed in the form of a band at a desired location on the electrical circuit-board, it is not necessary to pattern the optical waveguide in advance as in Patent Document 1. Consequently, a photoelectric composite device can be obtained that has high design freedom for an optical circuit.

### PRIOR ART DOCUMENTS

### Patent Documents

[Patent Document 1] Japanese Unexamined Patent Application, First Publication No. 2009-58923

[Patent Document 2] Japanese Unexamined Patent Application, First Publication No. 2010-49225

### DISCLOSURE OF THE INVENTION

### Problems to be Solved by the Invention

However, in the case of surface-mounting the conventional electrical optical circuit-board exemplified in Patent Document 2 on an electrical wiring board, since it is necessary to mount an electrical device while avoiding an optical waveguide, there is the problem of a decrease in mounting efficiency of the electrical device.

With the foregoing in view, the present invention provides an electrical optical circuit-board, a circuit-board apparatus and a photoelectric composite device that allow an optical waveguide to be installed at a desired location on an electrical circuit-board while also being able to enhance mounting efficiency of an electrical device.

### Means for Solving the Problems

The aforementioned object is achieved by the present invention described in (1) to (14) below.

(1) An electrical optical circuit-board provided with an optical circuit-board provided with an optical waveguide and an electrical wiring board that contains a conductor layer and is laminated on the optical circuit-board, wherein the electrical wiring board is provided with extending portions formed extending beyond the optical circuit-board, and conductive portions are provided on the extending portions.

(2) The electrical optical circuit-board described in (1) above, wherein the conductive portions electrically connect the conductor layer and the surface of the electrical wiring board on the side of the optical circuit-board.

(3) The electrical optical circuit-board described in (1) or (2) above, wherein the extending portions are formed at least laterally with respect to the extending direction of the optical waveguide.

(4) The electrical optical circuit-board described in (3) above, wherein the extending portions are formed over the entire circumference of the optical circuit-board.

(5) The electrical optical circuit-board described in any of (1) to (4) above, wherein a light path conversion mirror is provided in the optical waveguide, and the conductor layer is removed from the electrical wiring board for a local region that contains the light path conversion mirror.

(6) The electrical optical circuit-board described in (5) above, wherein an indicator portion that indicates the position of the light path conversion mirror is formed on the upper portion of the optical circuit-board except for the extending portions on the surface of the electrical wiring substrate.

(7) The electrical optical circuit-board described in any of (1) to (6) above, wherein the electrical wiring board is a flexible wiring board.

(8) The electrical optical circuit-board described in any of (1) to (7), wherein the conductor layer has pad portions formed by patterning, and through holes that electrically connect the pad portions and the side of the electrical wiring board on the side of the optical circuit-board are provided as the conductive portions.

(9) The electrical optical circuit-board according to any of (1) to (8) above, wherein an anisotropic conductive film electrically connected to the conductor layer is adhered to at least the extending portions to the sides of the electrical wiring board on the side of the optical circuit-board.

(10) A circuit-board apparatus having an electrical optical circuit-board provided with an optical circuit-board provided with an optical waveguide and an electrical wiring board that contains a conductor layer in which pad portions are patterned and is laminated on the optical circuit-board, and an electrical circuit-board on which an optical device or an electrical device is mounted, wherein, the electrical wiring board is provided with extending portions formed by extending beyond the optical circuit-board, conductive portions are provided in the extending portions that connect the conductor layer and the electrical circuit-board, and together with the electrical optical circuit-board being locally attached to the surface of the electrical circuit-board and the electrical optical circuit-board and the electrical circuit-board being electrically connected, the pad portions compose at least of a portion of a mounting region of the optical device or the electrical device.

(11) The circuit-board apparatus described in (10) above, wherein the electrical wiring board is a flexible wiring board, and the extending portions are connected to the electrical circuit-board by being bent so as to cover the lateral edges of the optical circuit-board in the extending direction thereof.

(12) The circuit-board apparatus described in (10) or (11) above, wherein the mounting region is composed extending over the pad portions and the electrical circuit-board.

(13) A photoelectric composite device having an electrical optical circuit-board provided with an optical circuit-board provided with an optical waveguide and an electrical wiring board that contains a conductor layer in which pad portions are patterned and is laminated on the optical circuit-board, and an electrical circuit-board on which an optical device or an electrical device is mounted, wherein the electrical wiring board is provided with extending portions formed by extending beyond the optical circuit-board, conductive portions are provided in the extending portions that connect the conductor layer and the electrical circuit-board, and together with the electrical optical circuit-board being locally attached to the surface of the electrical circuit-board and the electrical optical circuit-board and the electrical circuit-board being electrically connected, the optical device or the electrical device is mounted on the pad portions.

(14) The photoelectric composite device described in (13) above, wherein the electrical wiring board is a flexible wiring board, the extending portions are connected to the electrical circuit-board by being bent so as to cover the lateral edges of the optical circuit-board in the extending direction thereof, and the optical device or the electrical device is mounted across the lateral edges.

According to the present invention, since an electrical optical circuit-board can be adhered to and fixed on an electrical circuit-board using extending portions, an optical waveguide can be installed at an arbitrary location on the surface of the electrical circuit-board. At this time, since an optical device or electrical device can be mounted on pad portions of the electrical optical circuit-board, dead space of the device mounting region is not created on the electrical circuit-board by the optical waveguide. Furthermore, dead space refers to a region where electrical wiring cannot be formed on the uppermost surface of the electrical optical circuit-board, and is a region where devices can substantially not be mounted since a device and electrical wiring cannot be electrically connected even if a device is mounted due to the absence of electrical wiring.

Furthermore, each type of constituent feature of the present invention is not required to be present independently, but rather a plurality of constituent features are permitted to be formed as a single member, a single constituent feature is permitted to be formed with a plurality of members, a certain constituent feature may be a portion of another constituent feature, or a portion of a certain constituent feature and a portion of another constituent feature may overlap.

### Effects of the Invention

According to the present invention, an optical waveguide can be installed at a desired location of an electrical circuit-board, and the mounting efficiency of an electrical device can be enhanced.

### BRIEF DESCRIPTION OF THE DRAWINGS

FIG. 1A is perspective view of an electrical optical circuit-board according to a first embodiment.

FIG. 1B is a cross-sectional view taken along line B-B of FIG. 1A.

FIG. 1C is a cross-sectional view taken along line C-C of FIG. 1A.

FIG. 2 is a perspective view of a circuit-board apparatus according to a first embodiment.

FIG. 3 is a perspective view of a photoelectric composite device according to a first embodiment.

FIG. 4A is a cross-sectional view of a circuit-board apparatus according to a first embodiment.

FIG. 4B is a cross-sectional view of a photoelectric composite device according to a first embodiment.

FIG. 5 is a cross-sectional view of a circuit-board apparatus according to a first variation.

FIG. 6 is a cross-sectional view of a photoelectric composite device according to a second variation.

FIG. 7A is a cross-sectional view of a circuit-board apparatus according to a second embodiment.

FIG. 7B is a cross-sectional view of a circuit-board apparatus according to a variation of a second embodiment.

FIG. 8A is a bottom view of an electrical optical circuit-board according to a third embodiment.

FIG. 8B is a bottom view of an electrical optical circuit-board according to a fourth embodiment.

FIG. 8C is a bottom view of an electrical optical circuit-board according to a fifth embodiment.

FIG. 8D is a bottom view of an electrical optical circuit-board according to a sixth embodiment.

FIG. 8E is a bottom view of an electrical optical circuit-board according to a seventh embodiment.

### BEST MODE FOR CARRYING OUT THE INVENTION

Although the following provides an explanation of embodiments of the present invention based on the drawings, the present invention is not limited thereto. Constituents of the present invention can be added, omitted, substituted or altered in other ways provided they do not deviate from the gist thereof . Furthermore, in all drawings, the same reference symbols are used to indicate the same constituents, and explanations thereof are suitably omitted.

Furthermore, although the embodiments are explained by defining the vertical orientation thereof, this is done for the purpose of facilitating explanations of the relative relationships of constituents, and does not limit the orientation or direction of finished products according to the present invention at the time of the production or use thereof .

### First Embodiment

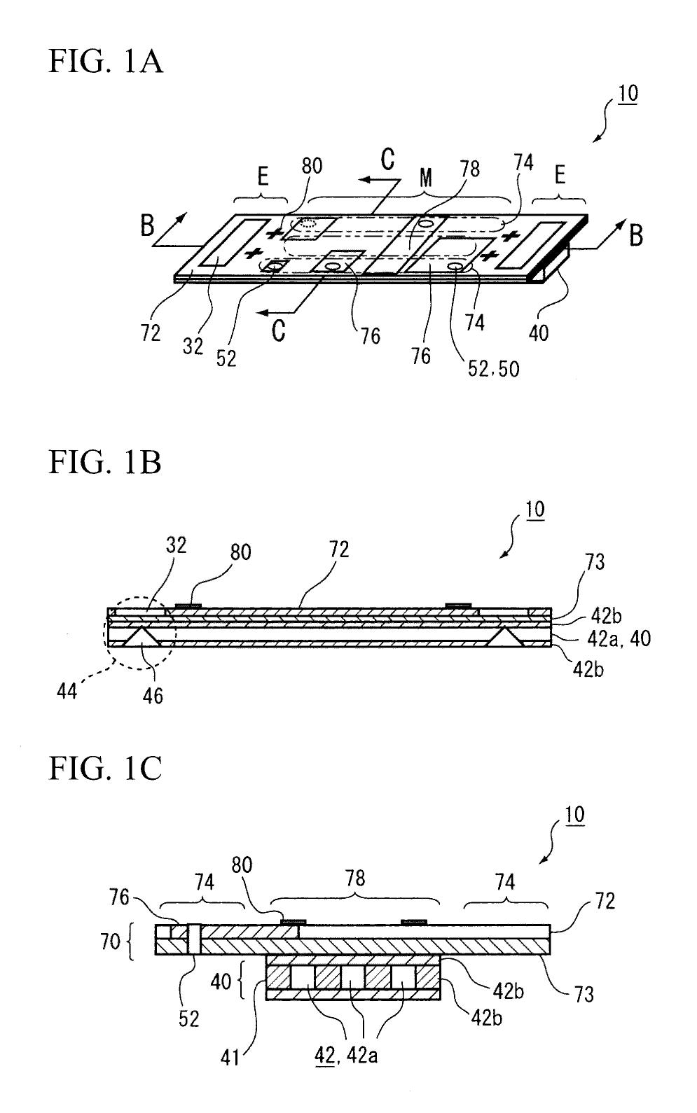

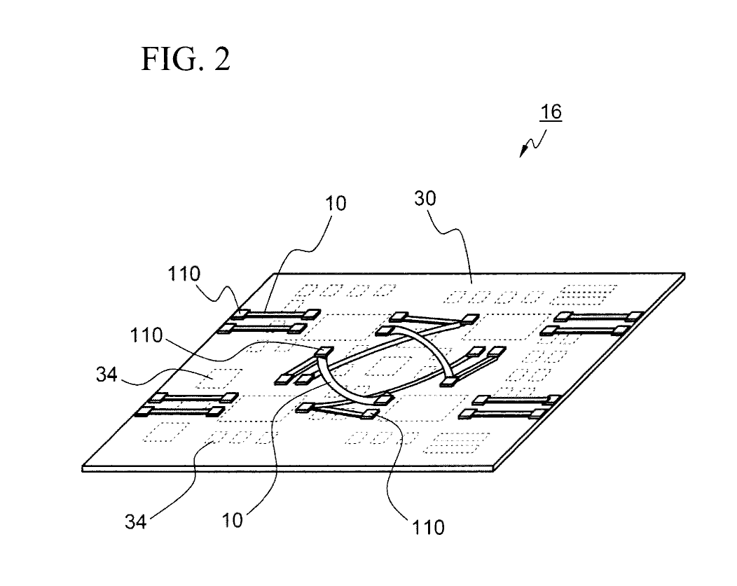

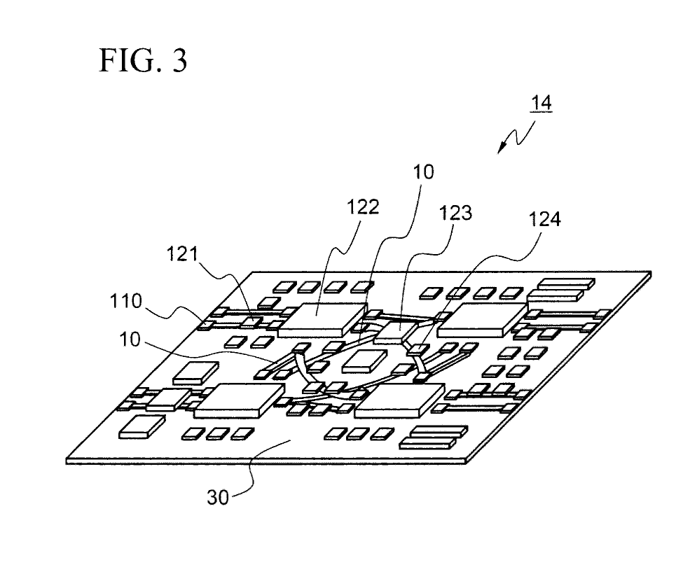

FIG. 1A is a perspective view of an electrical optical circuit-board 10 according to a first embodiment of the present invention. FIG. 13 is a cross-sectional view taken along line B-B of FIG. 1A, and FIG. 1C is a cross-sectional view taken along line C-C of FIG. 1A. FIG. 2 is a perspective view of a circuit-board apparatus 16 according to the present embodiment. FIG. 3 is a perspective view of a photoelectric composite device 14 according to the present embodiment.

To begin with, an explanation is provided of an overview of the electrical optical circuit-board 10, the circuit-board apparatus 16 and the photoelectric composite device 14 of the present embodiment.

As shown in FIG. 1, the electrical optical circuit-board 10 is provided with an optical circuit-board 40 provided with an optical waveguide 42, and an electrical wiring board 70 laminated on the optical circuit-board 40 and containing a conductor layer 72. In the electrical optical circuit-board 10 of the present embodiment, the electrical wiring board 70 is provided with extending portions 74 formed extending beyond the optical circuit-board 40, and conductive portions 50 are provided in the extending portions 74 that connect the conductor layer 72 and the back side of the electrical optical circuit-board 10. Furthermore, the conductor portions 50 are preferably contained in a middle portion M in the extending direction of the electrical wiring board 70.

According to this configuration, even in the case the electrical optical circuit-board 10 is attached and fixed to an electrical circuit-board 30 using the extending portions 74, an optical device 110 or an electrical device 120 (electrical devices 121 to 124 in FIG. 3) can be mounted on the conductor layer 72 of the electrical optical circuit-board 10. Accordingly, in the case of attaching this electrical optical circuit-board 10 to the electrical circuit-board 30, the photoelectric composite device 14 having high mounting efficiency can be realized without creating dead space in a device mounting region 34 (FIG. 2) on the electrical circuit-board 30.

The electrical optical circuit-board 10 and the electrical circuit-board 30 are collectively referred to as the circuit-board apparatus 16.

Namely, as shown in FIG. 2, the circuit-board apparatus 16 of the present embodiment contains the above-mentioned electrical optical circuit-board 10, and the electrical circuit-board 30 mounted with the optical device 110 or the electrical device 120. In the circuit-board apparatus 16 of the present embodiment, the electrical optical circuit-board 10 is locally attached to the surface of the electrical circuit-board 30, the back side of the electrical optical circuit-board 10 is electrically connected to the electrical circuit-board 30, and pad portions 76 formed by patterning the conductor layer 72 of the electrical optical circuit-board 10 compose at least a portion of the mounting region (device mounting region 34) of the optical device 110 or the electrical device 120.

Moreover, that in which the optical device 110 or the electrical device 120 is mounted on the circuit-board apparatus 16 is referred to as the photoelectric composite device 14.

Namely, as shown in FIG. 3, the photoelectric composite device 14 of the present embodiment contains the above-mentioned electrical optical circuit-board 10, the electrical circuit-board 30, and the optical device 110 or the electrical device 120. In the photoelectric composite device 14 of the present embodiment, the electrical optical circuit-board 10 is locally attached to the surface of the electrical circuit-board 30, the back of the electrical optical circuit-board 10 is electrically connected to the electrical circuit-board 30, and the optical device 110 or the electrical device 120 is mounted on the pad portions 76 formed by patterning the conductor layer 72 of the electrical optical circuit-board 10.

As shown in FIG. 3, in the photoelectric composite device 14 of the present embodiment, the electrical device 120 (electrical device 121) is mounted on the surface of the electrical optical circuit-board 10. In addition, the electrical device 120 (electrical device 122) is mounted across a plurality of the electrical optical circuit-boards 10. In addition, the electrical device 120 (electrical device 123) is also mounted on the upper portion of the intersecting portions of a plurality of the electrical optical circuit-boards 10. Moreover, the electrical device 120 (electrical device 124) is mounted extending over the electrical optical circuit-board 10 and the electrical circuit-board 30.

Next, a detailed explanation is provided of the electrical optical circuit-board 10, the circuit-board apparatus 16 and the photoelectric composite device 14 of the present embodiment.

Returning to FIG. 1, the electrical wiring board 70 contains an electrically conductive conductor layer 72, and a transparent adhesive layer 73 adhered to the lower surface thereof over roughly the entire surface thereof. The electrical wiring board 70 containing the conductor layer 72 means that an electrically conductive layer on the surface of or within the electrical wiring board 70 is formed by being patterned either partially or over the entire surface thereof. The conductor layer 72 is composed of a conductive material such as Cu, Ni, Al, Au, Pt or other metal material. The conductor layer 72 may be such that a sheet-like metal material is adhered over the entire upper surface of the adhesive layer 73, or may be provided with the pad portions 76 formed by patterning to a desired shape. The pad portions 76 may be formed in the extending portions 74 or may be formed by extending over a waveguide opposing portion 78 and the extending portions 74. Moreover, the pad portions 76 may also be formed over the entire electrical wiring board 70 in the direction of the width thereof (horizontal direction in FIG. 1C).

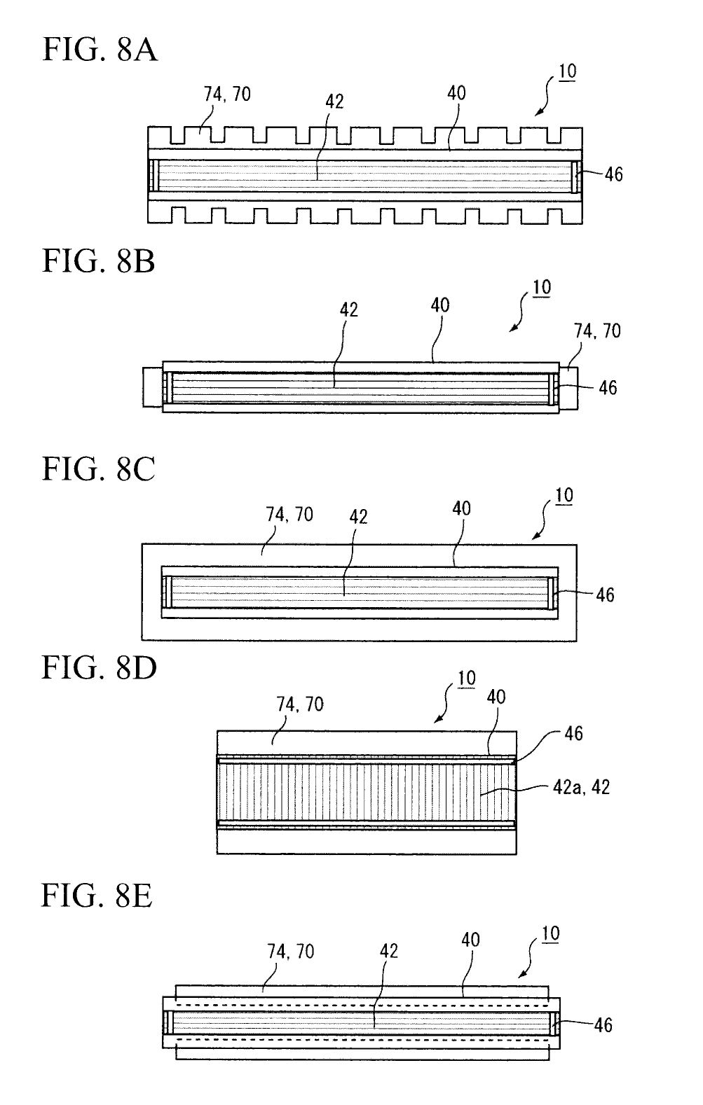

The extending portions 74 of the present embodiment are formed at least laterally with respect to the extending direction of the optical waveguide 42 (horizontal direction in FIG. 1A) . In the present embodiment, the extending portions 74 are formed protruding to both sides of the optical circuit-board 40 in the center in the extending direction of the optical waveguide 42. However, instead of the configuration of the present embodiment, the extending portions 74 may also extend in various directions with respect to the optical circuit-board 40 or may be formed over the entire circumference of the optical circuit-board (see FIG. 8C).

The extending portions 74 refer to partial regions protruding beyond the optical circuit-board 40 to the outside in the direction of width in the form of ledges . In the present embodiment, the extending portions 74 are used to fix the optical circuit-board 40 to the electrical circuit-board 30, and electrically connect the electrical wiring board 70 and the electrical circuit-board 30. Moreover, the optical device 110 or the electrical device 120 is mounted by providing the pad portions 76 on the extending portions 74.

The optical circuit-board 40, which is joined to the lower surface of the electrical wiring board 70, is a board in which the optical waveguide 42 is formed on all or a portion thereof . The optical waveguide 42 has linear core portions 42a and sheath-like clad portions 42b surrounding the periphery of the core portion 42a. Hatching has been omitted from the cross-sections of the core portions 42a in order to facilitate the explanation. The core portions 42a and the clad portions 42b have mutually different optical refractive indices. The optical circuit-board 40 is an optical member in which light that has entered an end portion or middle portion of the core portions 42a propagates there through while being completely reflected at the interface between the core portions 42a and the clad portions 42b. A plurality of the core portions 42a may also be provided and may be mutually separated by the clad portions 42b. The thickness of the optical waveguide 42 is preferably 15 μm to 200 μm and more preferably 30 μm to 100 μm.

In the present embodiment, the lengthwise direction of the core portions 42a and the clad portions 42a in the optical waveguide 42 refers to the horizontal direction of FIG. 1B, while the direction of thickness thereof refers to the vertical direction of FIG. 1B and the widthwise direction refers to the horizontal direction of FIG. 1C. The electrical optical circuit-board 10 of the present embodiment is in the form of a band, and the lengthwise direction thereof coincides with the extending direction of the optical waveguide 42. However, instead of the configuration of the present embodiment, the lengthwise direction of the optical waveguide 42 may be the direction in which the core portions 42a are arranged in the case the optical waveguide 42 is provided with a large number of the core portions 42a (see FIG. 8E).

The width dimension of the core portions 42a is preferably 1 μm to 200 μm, more preferably 5 μm to 100 μm, and even more preferably 10 μm to 60 μm. The thickness dimension of the core portions 42a is preferably 5 μm to 100 μm and more preferably 25 μm to 80 μm. On the other hand, the thickness of the clad portions 42b is preferably 3 μm to 50 μm and more preferably 5 μm to 30 μm.

There are no particular limitations on each constituent material of the core portions 42a and the clad portions 42b provided they are materials that result in a difference in the refractive indices thereof. Specific examples of materials that can be used include various types of resin materials in the manner of acrylic resins, methacrylic resins, polycarbonate, polystyrene, epoxy resin, polyamide, polyimide, polybenzoxazole, polysilane or polysilazane, and cyclic olefin-based resins such as benzocyclobutene-based resins or norbornene-based resins, as well as glass materials such as quartz glass or borosilicate glass.

A light path conversion portion 44 is provided in an end portion or middle portion of the optical waveguide 42. The light path conversion portion 44 is a region where light propagating within the plane of the optical circuit-board 40 and light propagating in a direction intersecting the optical circuit-board 40 (and typically the perpendicular direction) are mutually converted. A light path conversion mirror 46 having an inclined reflecting surface is typically arranged in the light path conversion portion 44.

The light path conversion mirror 46 is formed within the light path conversion portion 44 of the optical waveguide 42, and the reflective index of the inclined reflecting surface thereof differs from that of the core portions 42a. The light path conversion mirror 46 of the present embodiment can be formed by carrying out laser processing or grinding processing and the like on the optical waveguide 42. Furthermore, a reflective film may be deposited on the reflecting surface (mirror surface) of the light path conversion mirror 46 as necessary. A metal film such as an Au, Ag or Al film is used for the reflective film.

In the electrical optical circuit-board 10 of the present embodiment, the light path conversion mirror 46 is provided in the optical waveguide 42, and the conductor layer 72 of the electrical wiring board 70 is removed for the local region containing the light path conversion mirror 46.

As a result, openings 32 are formed in end portions E on both sides in the lengthwise direction of the electrical optical circuit-board 10, thereby enabling optical observation by the light path conversion mirror 46 of the optical circuit-board 40. Here, the lengthwise direction of the electrical optical circuit-board 10 may be the case of being linear as shown in FIG. 1 (horizontal direction in FIG. 1) or the case of being curved as shown in FIG. 2.

According to this configuration, the electrical wiring board 70 can be patterned to serve as a drive circuit of the optical device 110, and the optical device 110 can be mounted at a location corresponding to the upper portion of the light path conversion mirror 46 on the electrical wiring board 70. As a result, the waveguide opposing portion 78 of the electrical wiring board 70 on the electrical optical circuit-board 10 can be used as a mounting region of the optical device 110. In addition, as a result of forming the pad portions 76 on the conductor layer 72 corresponding to the upper surface of the electrical wiring board 70, the optical device 110 and the electrical device 120 can be mounted extending over the electrical wiring board 70 and the electrical circuit-board 30.

Examples of the optical device 110 include light-emitting devices such as surface-emitting lasers (VCSEL) and light-receiving devices such as photodiodes (PD and APD).

Various types of electrical devices can be used for the electrical device 120, examples of which include, in addition to driving devices for the optical device 110, semiconductor devices such as LSI or IC, resistors, condensers and inductors. Driving devices are obtained by, for example, combining an amplifier such as a transimpedance amplifier (TIA) or limiting amplifier (LA) with a control driver IC.

An indicator portion (alignment mark 80) that indicates the position of the light path conversion mirror 46 is formed on the upper portion (waveguide opposing portion 78) of the optical circuit-board 40 except for the extending portions 74 on the surface of the electrical wiring board 70.

As a result, the light path conversion mirror 46 that faces out from the openings 32 where the conductor layer 72 has been removed and the optical device 110 mounted on the electrical wiring board 70 can be aligned by using the indicator portion (alignment mark 80) as an indicator thereof.

The electrical wiring board 70 may be a rigid board having for a base material thereof a hard material such as a glass epoxy board, or may be a flexible board having for a base material thereof a flexible film such as a polyimide or polyester film. Among these, the electrical wiring board 70 of the present embodiment is a flexible wiring board. The specific configuration and properties of the flexible wiring board consist of a board thickness of preferably 0.005 mm to 0.3 mm and more preferably 0.01 mm to 0.3 mm. Copper foil thickness is preferably 0.1 μm to 50 μm and more preferably 0.5 μm to 30 μm. The dielectric constant is preferably 1.1 to 4.5 and more preferably 1.5 to 4.0. The dielectric tangent is preferably 0.0001 to 0.04 and more preferably 0.0005 to 0.03. In addition, the electrical wiring board may be a double-sided board where a conductor layer is formed on both sides of an insulating layer. In that case, an electrical circuit may be patterned in the conductor layer on the waveguide side. In addition, through holes may be provided for ensuring electrical continuity between conductor layers on both sides regardless of whether or not a circuit is formed.

As a result, the extending portions 74 in the electrical wiring board 70 can be bent so as to cover the lateral edges 41 of the optical circuit-board 40 along the extending direction of the optical waveguide 42. Consequently, even if the optical circuit-board 40 is installed on the surface of the electrical circuit-board 30, namely if the optical circuit-board 40 protrudes to the surface of the electrical circuit-board 30, the electrical optical circuit-board 10 can be attached to the electrical circuit-board 30 using the extending portions 74.

In the present embodiment, the extending portions 74 may be provided only on one side in the direction of width with respect to the waveguide opposing portion 78, or the extending portions 74 may be respectively formed on both sides as shown in FIG. 1. In addition, the extending portions 74 may be formed in the form of a band over the entire electrical wiring board 70 in the lengthwise direction thereof as shown in the drawings, or may be formed intermittently at a plurality of locations in the lengthwise direction (see FIG. 8A).

As shown in FIG. 1A, the pad portions 76 are formed by patterning the conductor layer 72 of the present embodiment, and through holes 52 that electrically connect the pad portions 76 and the back side of the electrical optical circuit-board 10 are provided in the form of the conductive portions 50.

As a result, the pad portions 76 are connected with the wiring of the electrical circuit-board 30 by aligning the pattern of the electrical circuit-board 30 with the through holes 52 of the electrical optical circuit-board 10.

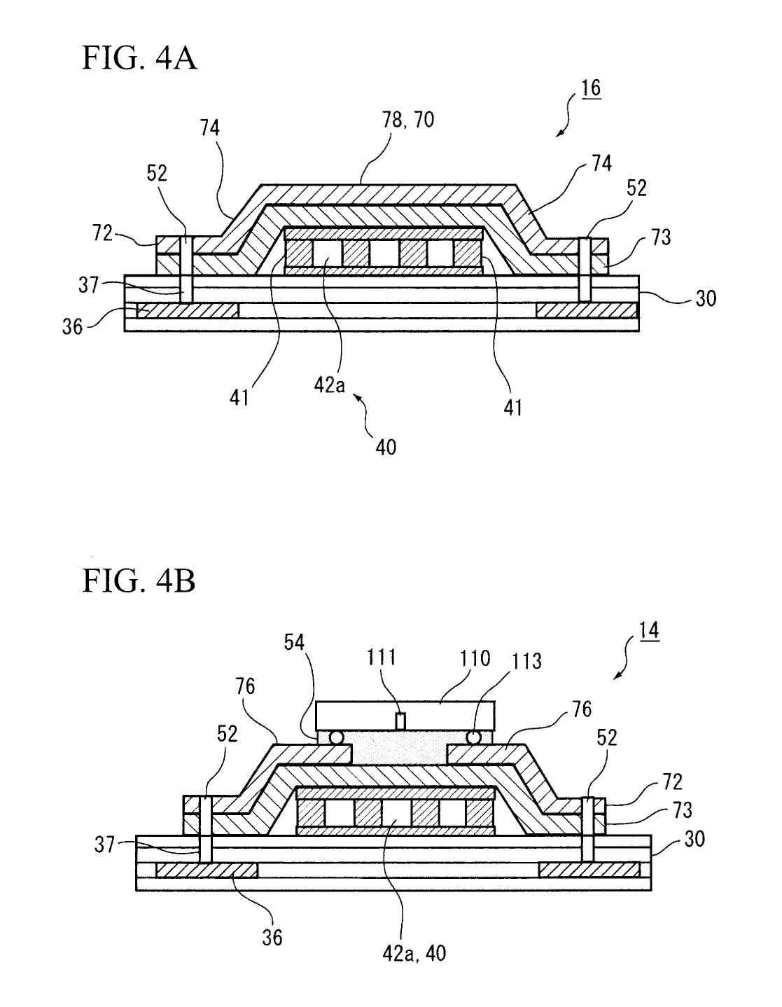

In the present embodiment, the through holes 52 are respectively formed for the plurality of pad portions 76. The optical device 110 or electrical device 120 mounted on the pad portions 76 are connected to a wiring layer 36 (see FIG. 4) of the electrical circuit-board 30 through the through holes 52.

In the present embodiment, the middle portion M, where the conductive portions 50 are provided that connect the conductor layer 72 with the back side of the electrical optical circuit-board 10, refers to a region of the electrical wiring board 70 except for the end portions E on both sides thereof having a length of a predetermined range that includes the center of the electrical wiring board 70 in the lengthwise direction.

FIG. 4A is a transverse cross-section relating to the middle portion M of the circuit-board apparatus 16 according to the present embodiment, while FIG. 4B is a cross-section of the photoelectric composite device 14.

The electrical wiring board 70 of the electrical optical circuit-board 10 is a flexible wiring board, and the extending portions 74 are connected to the electrical circuit-board 30 by being bent so as to cover the lateral edges 41 in the extending direction of the optical circuit-board 40.

The electrical circuit-board 30 is a rigid board that contains the wiring layer 36. Recess holes 37 are formed in the electrical circuit-board 30 that extend from the surface on which the adhesive layer 73 is adhered to at least the wiring layer 36. The recess holes 37 and the through holes 52 are mutually continuous. As a result, the optical device 110 or the electrical device 120 can be through-hole mounted on the wiring layer 36.

As shown in FIG. 4B, a plurality of solder mounting portions 113 of the optical device 110 are individually joined to the plurality of pad portions 76. The optical device 110 transfers optical signals with the core portions 42a of the optical circuit-board 40 through a light receiving/emitting portion 111.

An opening is formed in the conductor layer 72 directly beneath the light receiving/emitting portion 111, and light that has been reflected by the light path conversion mirror 46 (not shown in FIG. 4) passes through the conductor layer 72 towards the light receiving/emitting portion 111. A resin filler 54 is filled into this opening. An acrylic resin, polycarbonate resin, epoxy resin, silicone resin or norbornene resin, for example, can be used for the resin filler 54. The resin filler 54 has optical transmittance (transparency). The resin filler 54 is filled in over the entire light path from the core portions 42a to the light receiving/emitting portion ill. As a result, in the photoelectric composite device 14 of the present embodiment, high device mounting efficiency is realized in the electrical optical circuit-board 10 since the optical device 110 can be mounted on the upper portion of the optical circuit-board 40.

Furthermore, various variations of the present embodiment are permitted.

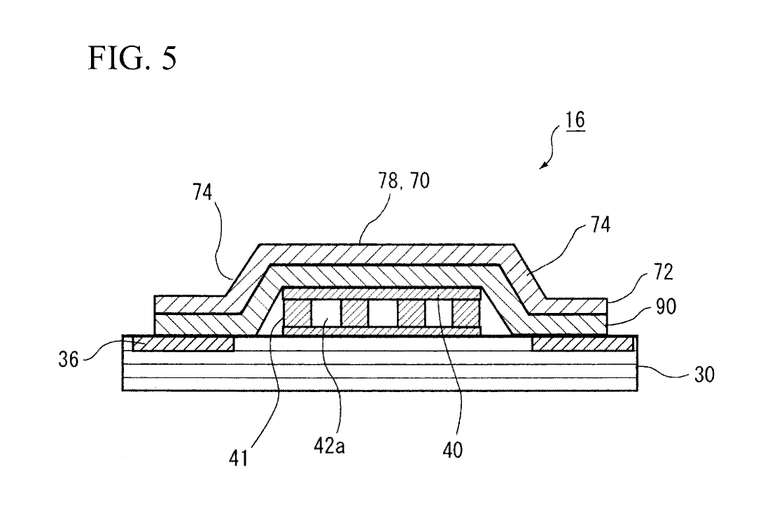

FIG. 5 is a cross-sectional view of the circuit-board apparatus 16 according to a first variation of the present embodiment.

The circuit-board apparatus 16 of the present variation has an anisotropic conductive film 90, electrically connected to the conductor layer 72 of the electrical wiring board 70, and adhered to at least to back side of the extending portions 74 of the electrical wiring board 70. Namely, the circuit-board apparatus 16 of the present embodiment is provided with the conductive portions 50 in the form of the anisotropic conductive film 90 that joins the wiring layer 36 of the electrical circuit-board 30 with the conductor layer 72 of the electrical wiring board 70. The wiring layer 36 of the electrical circuit-board 30 is exposed and patterned on the surface of the electrical circuit-board 30.

As a result of the present variation having the anisotropic conductive film 90 adhered to the back side of the extending portions 74, the back side of the electrical wiring board 70 and the pattern of the electrical circuit-board 30 are electrically connected by pressure-bonding the extending portions 74 to the electrical circuit-board 30.

The anisotropic conductive film is a thin layer in which conductor filler is dispersed in an insulating resin, and only a pressed local region is electrically conductive in the perpendicular direction thereof. Consequently, the conductor layer 72 is electrically connected to the pattern of the wiring layer 36 by pressing the extending portions 74, which are bent back along the lateral edges 41 of the optical circuit-board 40, against the pattern of the wiring layer 36.

According to the present variation, the conductor layer 72 of the electrical optical circuit-board 10 can be used for the device mounting region 34 (FIG. 2) of the optical device 110 or the electrical device 120 more easily and with a higher degree of design freedom without having to form the through holes 52 as the conductive portions 50. However, in addition to using the anisotropic conductive film 90, the electrical optical circuit-board 10 of the present variation does not preclude the further formation of the through holes 52 that pass through the electrical wiring board 70 and the anisotropic conductive film 90.

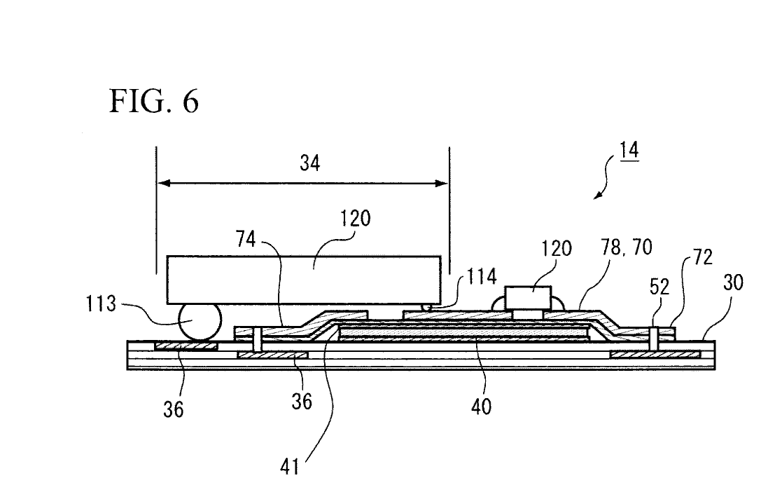

FIG. 6 is a cross-sectional view of the photoelectric composite device 14 according to a second variation of the present embodiment.

In the photoelectric composite device 14 of the present variation, the mounting region of the optical device 110 or the electrical device 120 (device mounting region 34) is composed extending over the pad portions 76 of the electrical wiring board 70 and the electrical circuit-board 30.

Namely, in the photoelectric composite device 14 of the present embodiment, the electrical wiring board 70 of the electrical optical circuit-board 10 is a flexible wiring board, the extending portions 74 are connected to the electrical circuit-board 30 by being bent so as to cover the lateral edges 41 in the extending direction of the optical circuit-board 40, and the optical device 110 or the electrical device 120 is mounted across the lateral edges 41 of the optical circuit-board 40.

As a result, the mounting region of the optical device 110 or the electrical device 120 (device mounting region 34) can be set at a desired location without distinguishing between the electrical circuit-board 30 and the electrical optical circuit-board 10, thereby realizing the circuit-board apparatus 16 having a high degree of device placement freedom.

In the present variation, the solder mounting portions 113 and 114 of the electrical device 120 have mutually different heights. One of the solder mounting portion 113 is mounted on the wiring layer 36 that is exposed on the surface of the electrical circuit-board 30, while the other solder mounting portion 114 is mounted on the conductor layer 72 in the waveguide opposing portion 78 of the electrical wiring board 70. Consequently, since the solder mounting portion 114 is at a higher location from the electrical circuit-board 30 than the solder mounting portion 113, the electrical device 120 is mounted level to the electrical circuit-board 30 by offsetting the diameters of the solder mounting portions 113 and 114.

### Second Embodiment

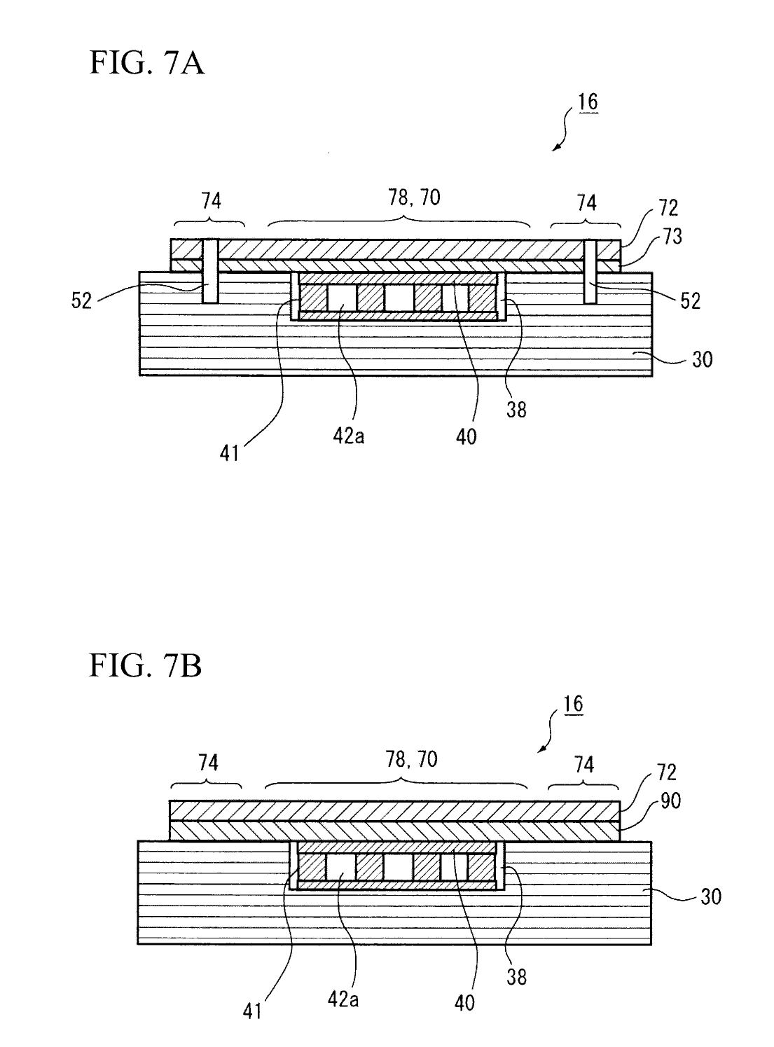

FIG. 7A is a cross-sectional view of the circuit-board apparatus 16 according to the present embodiment, while FIG. 7B is a cross-sectional view of the circuit-board apparatus 16 according to a variation thereof. The wiring layer 36 of the electrical circuit-board 30 is omitted in each drawing.

The circuit-board apparatus 16 of the present embodiment has a recess 38 capable of housing the optical circuit-board 40 formed in the electrical circuit-board 30. As a result, the waveguide opposing portion 78 and the extending portions 74 can be tightly adhered to the surface of the electrical circuit-board 30 without bending the extending portions 74 of the electrical wiring board 70. The width dimension of the recess 38 (dimension in the horizontal direction of FIG. 7) is larger than the width dimension of the optical circuit-board 40, while the depth dimension of the recess 38 is equal to or greater than the thickness dimension of the optical circuit-board 40.

Similar to the first embodiment, the circuit-board apparatus 16 shown in FIG. 7A is provided with the through holes 52 for the conductive portions 50. On the other hand, the circuit substrate apparatus 16 shown in FIG. 7B differs from the second embodiment in that it is provided with the anisotropic conductive film 90 for the conductive portions 50.

As shown in FIGS. 7A and 7B, according to the circuit substrate apparatus 16 of the present embodiment, the device mounting region 34 of the optical device 110 or the electrical device 120 can be secured on a flat surface extending over the entire surface of the electrical wiring board 70 since there is no height difference in height in the electrical wiring board 70 even in the vicinity of the lateral edges 41 of the optical circuit-board 40. In addition, since the thickness of the electrical wiring board 70 is extremely small, there is only a slight height difference between the surface of the conductor layer 72 and the surface of the electrical circuit-board 30. Consequently, the device mounting region 34 can be secured so as to extend across the electrical circuit-board 30 and the electrical optical circuit-board 10, or the device mounting region 34 can be secured across the electrical optical circuit-board 10. As a result, as shown in FIG. 3, the optical device 110 or the electrical device 120 can be mounted while being mutually overlapped with the optical waveguide 42 by the electrical optical circuit-board 10 over roughly the entire surface of the electrical circuit-board 30.

FIGS. 8A to 8E are bottom views of the electrical optical circuit-board 10 according to third to seventh embodiments as viewed from the side of the optical circuit-board 40.

The electrical optical circuit-board 10 of the third embodiment shown in FIG. 8A has the plurality of extending portions 74 protruding to both sides of the optical circuit-board 40 by respectively extending in the manner of fins intermittently arranged extending over the electrical optical circuit-board 10 in the lengthwise direction thereof (horizontal direction in the drawing). The light path conversion mirror 46 is provided on both ends of the optical circuit-board 40 in the lengthwise direction thereof. The electrical wiring board 70 is joined to the electrical circuit-board 30 by individually bending the large number of fin-like extending portions 74 (see FIG. 3). As a result, the electrical optical circuit-board 10 can be mounted on the electrical circuit-board 30 without causing interference between the optical device 110 or the electrical device 120 mounted on the electrical circuit-board 30 and the extending portions 74.

The electrical optical circuit-board 10 of the fourth embodiment shown in FIG. 8B is provided with the extending portions 74 on both ends of the optical circuit-board 40 in the lengthwise direction thereof. In this manner, in the electrical optical circuit-board 10 of the present invention, the direction in which the extending portions 74 extend is not limited to extending laterally with respect to the lengthwise direction of the optical circuit-board 40. In the case of the present embodiment, the extending portions 74 of the electrical wiring board 70 can be used as device mounting regions 34 of the optical device 110 mounted above the light path conversion mirror 46 . As a result, even if the light path conversion mirror 46 is mounted on the end portions of the optical circuit-board 40 in the lengthwise direction thereof or in extremely close proximity thereto, there is no shortage of the device mounting region 34 for the optical device 110 that transfers light with the aforementioned light path conversion mirror 46.

The electrical optical circuit-board 10 of the fifth embodiment shown in FIG. 8C has the extending portions 74 formed over the entire circumference of the optical circuit-board 40, including the sides thereof. Namely, the extending portions 74 of the present embodiment are respectively provided protruding from the four sides of the optical circuit-board 40 in shape of a rectangle (band). Moreover, the electrical optical circuit-board 10 of the present embodiment has annular extending portions 74 formed by linking the four corners protruding from the optical circuit-board 40. As a result, the electrical optical circuit-board 10 can be stably attached to the electrical circuit-board 30 over the entire circumference thereof regardless of the aspect ratio of the optical circuit-board 40.

The electrical optical circuit-board 10 of the sixth embodiment shown in FIG. 8D has a large number of the core portions 42a arranged horizontally in a row, and the width of the optical circuit-board 40 is larger than the individual lengths of the optical waveguide 42 (core portions 42a). The lengthwise direction of the electrical optical circuit-board 10 coincides with the direction in which the core portions 42a are arranged. In the present embodiment, the extending portions 74 extend by protruding in the extending direction of the optical waveguide 42 along the lengthwise direction of the electrical optical circuit-board 10.

The electrical optical circuit-board 10 of the seventh embodiment shown in FIG. 8E has the extending portions 74 preliminarily fabricated in the form of a narrow band integrated into a single unit by, for example, affixing to the main surface of the optical circuit-board 40 with an adhesive and the like. Namely, the electrical wiring board 70 of the present embodiment may be composed with a single member as in the first to sixth embodiments, or may be composed of a plurality of members as in the present embodiment. In the present embodiment, roughly half of the band-like extending portions 74 in the width dimension thereof are respectively joined by protruding from the optical circuit-board 40 on both sides of the optical waveguide 42 along the extending direction thereof, namely along the opposing long sides of the optical circuit-board 40. In this manner, by integrating the extending portions 74 into a single unit by adhering so as to protrude from the optical circuit-board 40, the device mounting region 34 can be obtained by providing the extending portions 74 at arbitrary locations with respect to the optical circuit-board 40 (see FIG. 2). Furthermore, in the case of the present embodiment, affixing the extending portions 74 while avoiding the upper portion of the light path conversion mirror 46 eliminates the need to provide the openings 32 (see FIG. 1A).

As has been explained above, the electrical optical circuit-board 10 and the photoelectric composite device 14 of the present invention enable the extending portions 74 to be formed at a desired location and in a desired shape for the optical waveguide 42 having an arbitrary shape.

### INDUSTRIAL APPLICABILITY

An electrical optical circuit-board can be provided that allows an optical waveguide to be installed at a desired location on an electrical circuit-board, while also enhancing the mounting efficiency of an electrical device.

### BRIEF DESCRIPTION OF THE REFERENCE SYMBOLS

10 Electrical optical circuit-board
14 Photoelectric composite device
16 Circuit-board apparatus
30 Electrical circuit-board
32 Opening
34 Device mounting region
36 Wiring layer
37 Recess hole
38 Recess
40 Optical circuit-board
41 Lateral edge
42 Optical waveguide
42a Core portion
42b Clad portion
44 Light path conversion portion
46 Light path conversion mirror
50 Conductive portion
52 Through hole
54 Resin filler
70 Electrical wiring board
72 Conductor layer
73 Adhesive layer
74 Extending portion
76 Pad portion
78 Waveguide opposing portion
80 Alignment mark
90 Anisotropic conductive film
110 Optical device
111 Light receiving-emitting portion
113,114 Solder mounting portions
120 to 124 Electrical devices
E End portion
M Middle portion

1. An electrical optical circuit-board provided with an optical circuit-board provided with an optical waveguide and an electrical wiring board that contains a conductor layer and is laminated on the optical circuit-board, wherein
the electrical wiring board is provided with extending portions formed extending beyond the optical circuit-board, and
conductive portions are provided on the extending portions.

2. The electrical optical circuit-board according to claim 1, wherein the conductive portions electrically connect the conductor layer and the surface of the electrical wiring board on the side of the optical circuit-board.

3. The electrical optical circuit-board according to claim 1, wherein the extending portions are formed at least laterally with respect to the extending direction of the optical waveguide.

4. The electrical optical circuit-board according to claim 3, wherein the extending portions are formed over the entire circumference of the optical circuit-board.

5. The electrical optical circuit-board according to claim 1, wherein a light path conversion mirror is provided in the optical waveguide and the conductor layer is removed from the electrical wiring board for a local region that contains the light path conversion mirror.

6. The electrical optical circuit-board according to claim 5, wherein an indicator portion that indicates the position of the light path conversion mirror is formed on the upper portion of the optical circuit-board except for the extending portions on the surface of the electrical wiring substrate.

7. The electrical optical circuit-board according to claim 1, wherein the electrical wiring board is a flexible wiring board.

8. The electrical optical circuit-board according to claim 1, wherein the conductor layer has pad portions formed by patterning, and through holes that electrically connect the pad portions and the side of the electrical wiring board on the side of the optical circuit-board are provided as the conductive portions.

9. The electrical optical circuit-board according to claim 1, wherein an anisotropic conductive film electrically connected to the conductor layer is adhered to at least the extending portions to the sides of the electrical wiring board on the side of the optical circuit-board.

10. A circuit-board apparatus having an electrical optical circuit-board provided with an optical circuit-board provided with an optical waveguide and an electrical wiring board that contains a conductor layer in which pad portions are patterned and is laminated on the optical circuit-board, and
an electrical circuit-board on which an optical device or an electrical device is mounted, wherein,
the electrical wiring board is provided with extending portions formed by extending beyond the optical circuit-board,
conductive portions are provided in the extending portions that connect the conductor layer and the electrical circuit-board, and together with the electrical optical circuit-board being locally attached to the surface of the electrical circuit-board and the electrical optical circuit-board and the electrical circuit-board being electrically connected,
the pad portions compose at least of a portion of a mounting region of the optical device or the electrical device.

11. The circuit-board apparatus according to claim 10, wherein the electrical wiring board is a flexible wiring board and the extending portions are connected to the electrical circuit-board by being bent so as to cover the lateral edges of the optical circuit-board in the extending direction thereof.

12. The circuit-board apparatus according to claim 10, wherein mounting region is composed extending over the pad portions and the electrical circuit-board.

13. A photoelectric composite device having an electrical optical circuit-board provided with an optical circuit-board provided with an optical waveguide, and an electrical wiring board that contains a conductor layer in which pad portions are patterned and is laminated on the optical circuit-board, and
an electrical circuit-board on which an optical device or an electrical device is mounted, wherein
the electrical wiring board is provided with extending portions formed by extending beyond the optical circuit-board,
conductive portions are provided in the extending portions that connect the conductor layer and the electrical circuit-board, and together with the electrical optical circuit-board being locally attached to the surface of the electrical circuit-board and the electrical optical circuit-board and the electrical circuit-board being electrically connected,
the optical device or the electrical device is mounted on the pad portions.

14. The photoelectric composite device according to claim 13, wherein the electrical wiring board is a flexible wiring board, the extending portions are connected to the electrical circuit-board by being bent so as to cover the lateral edges of the optical circuit-board in the extending direction thereof, and the optical device or the electrical device is mounted across the lateral edges.
